(19) United States
(12) Patent Application Publication
(10) Pub. No.: US 2007/0110396 A1
(43) Pub. Date: May 17, 2007

(54) Data processor

(76) Inventors: Masanori Itoh, Moriguchi-shi (JP); Tadashi Nakamura, Nara-shi (JP)

Correspondence Address: MARK D. SARALINO (MEI);RENNER, OTTO, BOISSELLE & SKLAR, LLP, 1621 EUCLID AVENUE, 19TH FLOOR, CLEVELAND, OH, 44115, US

(21) Appl. No.: 10/566,341

(22) PCT Filed: Jul. 29, 2004
(86) PCT No.: PCT/JP04/11222

§ 371 Date: Jan. 27, 2006

(30) Foreign Application Priority Data
Jul. 30, 2003 (JP) 2003-282589

(51) Int. Cl. H04N 7/00

(52) U.S. Cl. 386/95

(57) ABSTRACT

A player reads content data from a continuous area on a storage medium and plays back video and/or audio based on the content data. The continuous area includes a data area, in which the content data is stored, and a non-content-data area, in which the content data is not stored. The player includes: a reading control section for giving an instruction to read the content data of a predefined size from the data area and an instruction to start to play back the video and/or the audio based on the content data that has been read out; a head for reading the content data from the data area in accordance with the instruction to read; and a buffer memory for accumulating the content data that has been read. The reading control section determines the predefined size by the amount of time it takes to skip the non-data area, reads the content data of the predefined size, accumulates the data in the buffer memory, and then gives an instruction to start to play back the content.

### TECHNICAL FIELD

The present invention relates to a data processor and processing method for storing stream data of a moving picture stream on a storage medium such as an optical disk.

### BACKGROUND ART

Various types of data streams for compressing and encoding video data at low bit rates have been standardized. A system stream compliant with the MPEG-2 system standard (ISO/IEC 13818-1) is known as one such data stream. There are three types of system streams, namely, a program stream (PS), a transport stream (TS) and a PES stream.

Video data and audio data would often be recorded on a magnetic tape in the past. Recently, however, optical disks such as DVD-RAMs and MOs have attracted much attention as storage media that will soon replace magnetic tapes.

FIG. 1 shows a configuration for a conventional data processor 350. The data processor 350 can record and play back a data stream on/from a DVD-RAM disk 131.

First, it will be described how the data processor 350 performs its recording operation. The data processor 350 receives a video data signal at a video signal input section 300 and an audio data signal at an audio signal input section 302, respectively, and sends them to an MPEG-2 compressing section 301. The MPEG-2 compressing section 301 compresses and encodes the video data and audio data in accordance with the MPEG-2 standard to generate a video stream and an audio stream. Thereafter, the MPEG-2 compressing section 301 further multiplexes these streams together, thereby generating a moving picture stream. The data of the moving picture stream is once stored in a buffer memory 322. A writing control section 341 controls the operation of a writing section 320. In accordance with an instruction given by the writing control section 341, a continuous data area detecting section 340 checks the availability of sectors being managed by a logical block management section 343, thereby detecting physically continuous unused areas (continuous data areas). Then, the writing section 320 reads the moving picture stream data from the buffer memory 322 and gets the data written on the DVD-RAM disk 331 by a pickup 330. As used herein, the “continuous data area” is a physically continuous logical block, of which the length corresponds to at least 11 seconds when converted at the maximum write rate. The minimum value of the continuous data areas will be referred to herein as either a “minimum continuous length” or just a “minimum size”.

Next, it will be described how the data processor 350 performs its playback operation. The data processor 350 gets a moving picture stream stored in the buffer memory 322 via the pickup 330 and a reading section 321. When an MPEG-2 decoding section 311 decodes the moving picture stream and generates video data and audio data, a video signal output section 310 and au audio signal output section 312 output a video signal and an audio signal, respectively. The readout of data from the DVD-RAM disk and the output of the read data to the MPEG-2 decoding section 311 are carried out concurrently. In this case, the data read rate is set higher than the data output rate, thereby performing a control operation such that the data to present does not run short. Accordingly, if data keeps being read and output continuously, then extra data can be obtained by the difference between the data read rate and the data output rate. By using the extra data as output data while the data read operation is discontinued by the pickup's jump, continuous playback is realized. An apparatus operating in this manner is disclosed in Japanese Patent Application Laid-Open Publication No. 2000-013728, for example.

Portion (a) of FIG. 2 shows continuous data areas and portion (b) of FIG. 2 shows a variation in the amount of the extra data that has been read out from the continuous data areas and then accumulated in the buffer memory 322. Suppose the rate Vr at which data is read out from the DVD-RAM disk 331 is 11 Mbps, the maximum rate Vo at which the data is output to the MPEG-2 decoding section 311 is 8 Mbps, and the longest time it takes for the pickup to make a move (i.e., the longest seek time) is 3 seconds. The data processor 350 begins playback on starting readout.

Since no data can be read for those three seconds, in which the pickup is moving (i.e., performing the seek operation), the data processor 350 needs to store data of 24 megabits, corresponding to the amount of data that can be transferred in three seconds at the data output rate Vo, in the buffer memory 322. To get this amount of data, reading needs to be performed continuously for eight seconds. This amount of time to accumulate the extra data is obtained by dividing 24 megabits by the difference (of 3 Mbps) between the data read rate of 11 Mbps and the data output rate of 8 Mbps.

Accordingly, during the continuous read operation of eight seconds, the data processor 350 reads data of 88 megabits, i.e., data to be output in 11 seconds. Consequently, by securing a continuous data area corresponding to at least 11 seconds, continuous data playback can be guaranteed. For example, data corresponding to a video playback duration of 11 seconds is contained in the continuous data area A1 that starts at a start address A1_S and ends at an end address A1_E. The area length of the continuous data areas A2, etc. that follow the area A1 is also determined by the same standard as that of the area A1. That is why data corresponding to a video playback duration of 11 seconds is also contained in the continuous data area A2 that starts at a start address A2_S and ends at an end address A2_E.

Some defective area including several defective logical blocks and/or a non-content data area including other data not to be played back may be present somewhere in each continuous data area. For example, suppose a continuous data area is allowed to include defective logical blocks corresponding to 5% or less of a unit data size (e.g., the minimum size of continuous data areas). In that case, the length of the continuous data area needs to correspond to more than 11 seconds with the amount of readout time it takes to skip the defective areas taken into account.

Portion (a) of FIG. 3 shows continuous data areas Bn (where n is a natural number), including defective areas bn, and portion (b) shows a variation in the amount of the extra data that has been read out from the continuous data areas and then accumulated in the buffer memory 322. Suppose a defective area b1 is present at the end of the continuous data area B1 and another defective area b2 is present at the beginning of the continuous data area B2 for the sake of convenience. Also, the longest seek time Tseek is supposed to be three seconds as in the example shown in portion (b) of FIG. 2.

The data processor 350 can read no data not only during the seek operation but also during periods of time Ts to skip the defective areas b1 and b2. That is why the data processor 350 needs to store data of (24M+Vo·2 Ts) bits, corresponding to the amount of data output to the MPEG-2 decoding section 311, in the buffer memory 322. And to get this amount of data, reading needs to be performed continuously for (8+Vo·2 Ts/3) seconds.

That is to say, if the defective areas b1 and b2 are included, the area Bn should be long enough to enable reading continuously (Vo·2 Ts/3) seconds longer than the continuous data area An (see portion (a) of FIG. 2). This means that supposing a worst-case scenario in which defective logical blocks have been generated most, the minimum length of continuous data areas should be defined so as to store audio/video data accounting for 10% of a continuous data area, i.e., the sum of the defective area (5%) of the continuous data area and that (5%) of the next continuous data area.

However, if the minimum length of continuous data areas were defined according to this standard, then that minimum length would be significantly long. In that case, if the user deleted unnecessary portions to leave empty areas in fragments on the optical disk and if all of those empty areas had short area lengths, then those empty areas could not be used for recording to be done newly. That is to say, even if there were sufficient empty areas in total, recording still could not be done due to the fragmentation, which is a problem.

Also, in making a combining editing to play back seamlessly two or more scenes of a moving picture stream that is stored on a disk, continuous data areas need to be got again and portions of the continuous data areas around the combining points need to be stored again. In that case, it may be sometimes difficult to get the continuous data areas required and the editing processing sometimes cannot be done so as to guarantee the seamless playback.

An object of the present invention is to reduce the minimum size of continuous data areas while permitting the continuous data areas to include areas not to play back (e.g., defective areas that are present at a similar rate to conventional ones).

### DISCLOSURE OF INVENTION

A data processor (or player) according to the present invention reads content data from a continuous area on a storage medium and plays back video and/or audio based on the content data. The continuous area includes a data area, in which the content data is stored, and a non-content-data area, in which the content data is not stored. The data processor includes: a reading control section for giving an instruction to read the content data of a predefined size from the data area and an instruction to start to play back the video and/or the audio based on the content data that has been read out; a head for reading the content data from the data area in accordance with the instruction to read; and a buffer memory for accumulating the content data that has been read. The reading control section determines the predefined size by the amount of time it takes to skip the non-data area, reads the content data of the predefined size, accumulates the data in the buffer memory, and then gives an instruction to start to play back the content.

The reading control section may determine the predefined size by a data read rate at which the content data is read, too.

The content data may be encoded data representing the video and/or the audio. The player may further include a decoding section for reading the content data of the predefined size from the buffer memory and decoding the content data in accordance with the instructions given by the reading control section.

The minimum area length of the continuous area may be determined by a data read rate, which has been defined based on a required data rate to play back the content and on a unit time to perform the playback, and by the size of extra data to be accumulated in the buffer memory. The size of the extra data may be determined by a data size, which has been defined on the longest seek time it takes to reach the next continuous area and a data rate required for playback during the longest seek time, and by the predefined size.

The continuous area may have an area length that is at least equal to the minimum area length.

Another data processor according to the present invention reads content data from a continuous area on a storage medium and plays back video and/or audio based on the content data. The continuous area includes a data area, in which the content data is stored, and a non-content-data area, in which the content data is not stored. The data processor includes: a reading control section for giving an instruction to read the content data from the data area for a predetermined period of time and an instruction to start to play back the video and/or the audio based on the content data that has been read out; a head for reading the content data from the data area in accordance with the instruction to read; and a buffer memory for accumulating the content data that has been read. The reading control section determines the predetermined period of time by the amount of time it takes to skip the non-data area, reads the content data for the predetermined period of time, accumulates the data in the buffer memory, and then gives an instruction to start to play back the content.

A data processing method according to the present invention is designed to read content data from a continuous area on a storage medium and play back video and/or audio based on the content data. The continuous area includes a data area, in which the content data is stored, and a non-content-data area, in which the content data is not stored. The data processing method includes the steps of: giving an instruction to read the content data of a predefined size from the data area; reading the content data from the data area in accordance with the instruction to read; accumulating the content data that has been read; and giving an instruction to start to play back the video and/or the audio based on the content data. The step of giving an instruction to read includes determining the predefined size by the amount of time it takes to skip the non-data area. The step of giving an instruction to start to play back includes accumulating the content data of the predefined size by performing the step of accumulating and then giving the instruction to start to play back.

The step of giving an instruction to read may include determining the predefined size by a data read rate at which the content data is read, too.

The content data may be encoded data representing the video and/or the audio, and the data processing method may further include the step of decoding the content data.

The minimum area length of the continuous area may be determined by a read data size, which has been defined based on a required data rate to play back the content and on a unit time to perform the playback, and by the size of extra data to be accumulated in the buffer memory. The size of the extra data may be determined by a data size, which has been defined on the longest seek time it takes to reach the next continuous area and a data rate required for playback during the longest seek time, and by the predefined size.

The continuous area may have an area length that is at least equal to the minimum area length.

The non-content-data area may include at least one of a defective area, of which the area length corresponds to at most a permissible defect rate for the continuous area, and a data area including data other than the content data.

A playback method according to the present invention is designed to read content data from a continuous area on a storage medium and play back video and/or audio based on the content data. The continuous area includes a data area, in which the content data is stored, and a non-content-data area, in which the content data is not stored. The playback method includes the steps of: giving an instruction to read the content data from the data area for a predetermined period of time; giving an instruction to start to play back the video and/or the audio based on the content data that has been read; reading the content data from the data area in accordance with the instruction to read; and accumulating the content data that has been read. The step of giving an instruction to read includes determining the predetermined period of time by the amount of time it takes to skip the non-data area. The step of giving an instruction to start to play back includes reading the content data for the predetermined period of time and accumulating the content data in the buffer memory by performing the step of accumulating and then giving the instruction to start to play back the content.

A computer program according to the present invention makes a computer function as a data processor for reading content data from a continuous area on a storage medium and playing back video and/or audio based on the content data when loaded into, and executed by, the computer. The continuous area of the storage medium includes a data area, in which the content data is stored, and a non-content-data area, in which the content data is not stored. By executing the computer program, the data processor performs the steps of: giving an instruction to read the content data of a predefined size from the data area; reading the content data from the data area in accordance with the instruction to read; accumulating the content data that has been read; and giving an instruction to start to play back the video and/or the audio based on the content data. The step of giving an instruction to read includes determining the predefined size by the amount of time it takes to skip the non-data area. The step of giving an instruction to start to play back includes accumulating the content data of the predefined size by performing the step of accumulating and then giving the instruction to start to play back.

The computer program may be stored on a storage medium.

Another data processor according to the present invention can write content data, representing video and/or audio, on a continuous area on a storage medium. The continuous area includes a data area, in which the content data is storable, and a non-content-data area, in which the content data is not stored. The data processor includes: a detecting section for detecting a continuous area, of which the length is equal to or greater than a predetermined area length, in accordance with an instruction; a writing control section for giving an instruction to detect the continuous area and an instruction to write the content data of a predefined size on the data area detected; and a head for writing the content data on the data area in accordance with the instruction to write. The writing control section retains a skip time it takes for an apparatus loaded with the storage medium to skip the non-data area in order to play back the video and/or the audio and determines the predetermined area length by the skip time.

A storage medium according to the present invention includes a continuous area having a data area, in which content data is storable, and a non-content-data area, in which the content data is not stored. Content data representing video and/or audio has been written on the data area. The area length of the continuous area is determined by a skip time it takes for an apparatus loaded with the storage medium to skip the non-data area in order to play back the video and/or the audio.

### BRIEF DESCRIPTION OF DRAWINGS

FIG. 1 shows a configuration for a conventional data processor 350.

Portion (a) of FIG. 2 shows continuous data areas and portion (b) of FIG. 2 shows a variation in the amount of the extra data that has been read out from the continuous data areas and then accumulated in the buffer memory 322.

Portion (a) of FIG. 3 shows continuous data areas Bn (where n is a natural number), including defective areas bn, and portion (b) shows a variation in the amount of the extra data that has been read out from the continuous data areas and then accumulated in the buffer memory 322.

FIG. 4 shows an arrangement of functional blocks in a data processor 10.

FIG. 5 shows an exemplary data structure of an MPEG2-PS 20.

FIG. 6 shows how the program stream 20 is correlated with a storage area on a DVD-RAM disk 131.

FIG. 7 shows how the stored data is managed by the file system of the DVD-RAM disk 131.

FIG. 8 shows a procedure of recording processing done by the data processor 10 of this preferred embodiment.

Portion (a) of FIG. 9 shows a conventional continuous data area A1 with no defective areas; portion (b) of FIG. 9 shows a conventional continuous data area B1 with a defect rate of 5% per minimum continuous length; portion (a) of FIG. 9 shows a continuous data area C1 according to this preferred embodiment with a defect rate of 5% per minimum continuous length; and portion (d) of FIG. 9 shows variations in the amount of extra data accumulated.

FIG. 10 shows a procedure of playback processing done by the data processor 10 of this preferred embodiment.

Portion (a) of FIG. 11 shows continuous data areas Cn according to this preferred embodiment, while portion (b) thereof shows a variation in the amount of extra data that has been read out from the continuous data areas Cn and then accumulated in the buffer memory 122.

FIG. 12 shows a variation in the amount of extra data that has been read out from a continuous data area C1 during the playback operation and then accumulated in the buffer memory 122, where non-content data is distributed relatively uniformly in the continuous data area.

FIG. 13 shows a variation in the amount of extra data that has been read out from the continuous data area C1 during the playback operation and then accumulated in the buffer memory 122, where non-content data is concentrated at the top portion of the continuous data area C1.

FIG. 14 shows the order of operations to be done by the pickup 130 in playing back video and audio synchronously with each other.

FIG. 15 shows variations in the respective amounts of video data and audio data to be accumulated in the buffer memory 122 in a situation where those data are read in the order of reading shown in FIG. 12.

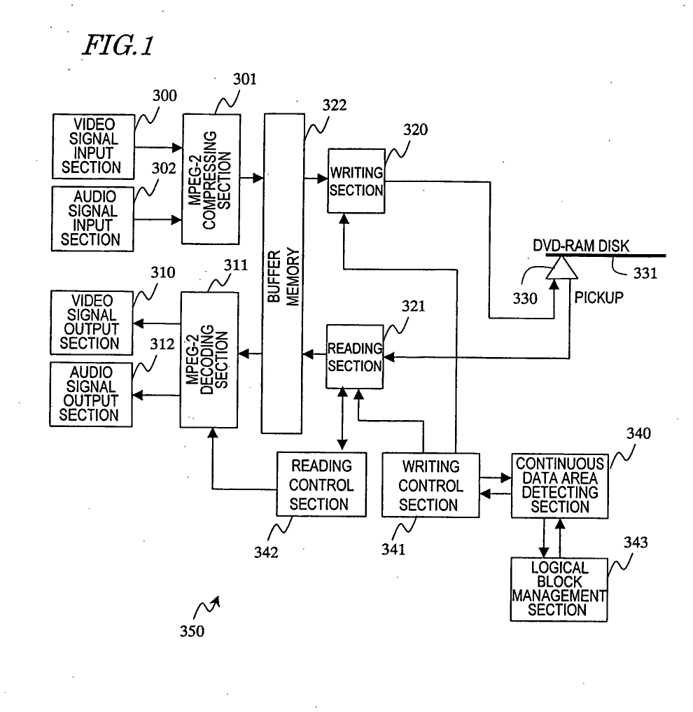

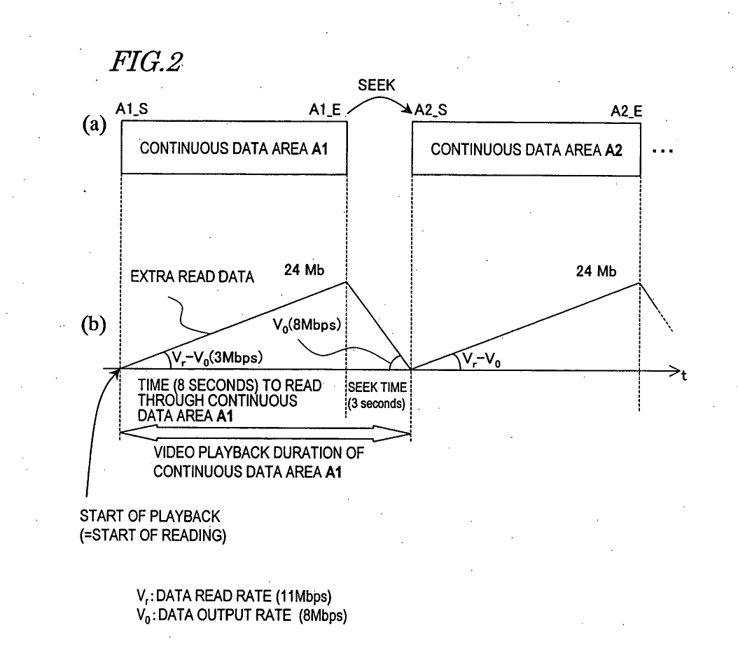

### BEST MODE FOR CARRYING OUT THE INVENTION

### Embodiment 1

Hereinafter, a data processor according to a first preferred embodiment of the present invention will be described with reference to the accompanying drawings.

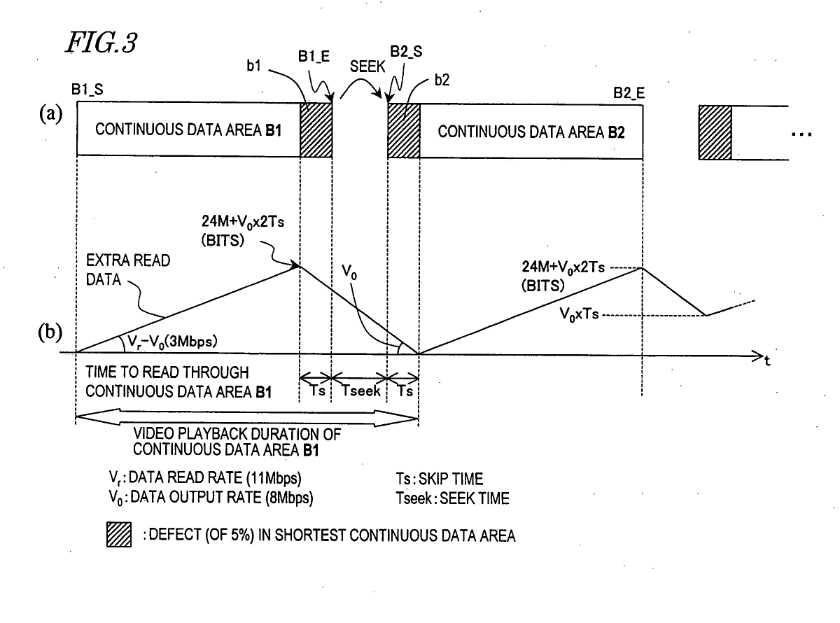

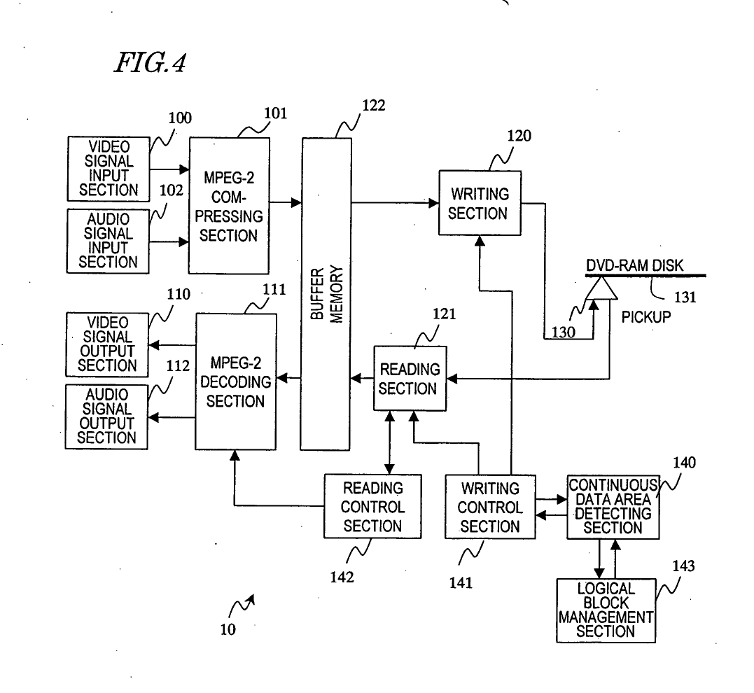

FIG. 4 shows an arrangement of functional blocks in a data processor 10 according to this preferred embodiment. In the following description, the data processor 10 is supposed to have the capabilities of both recording and playing a moving picture stream representing video and/or audio. More specifically, the data processor 10 can not only generate a moving picture stream and store it on a DVD-RAM disk 131 but also play back video and/or audio from the moving picture stream stored. The data processor may be implemented as a DVD recorder, a portable video recorder, a movie recorder, or a PC with a DVD-RAM drive.

First, the recording function of the data processor 10 will be described. The data processor 10 includes a video signal input section 100, an MPEG2-PS compressing section 101, an audio signal input section 102, a writing section 120, a buffer memory 122, an optical pickup 130, a writing control section 141, a continuous data area detecting section 140 and a logical block management section 143 as respective components regarding this function.

The video signal input section 100 is implemented as a video signal input terminal and receives a video signal representing video data. The audio signal input section 102 is implemented as an audio signal input terminal and receives an audio signal representing audio data. For example, the video signal input section 100 and audio signal input section 102 may be connected to the video output section and audio output section of a tuner (not shown) to receive a video signal and an audio signal, respectively. Alternatively, the video signal input section 100 and audio signal input section 102 may be connected to a camera section and a microphone section, respectively.

The MPEG2-PS compressing section (which will be simply referred to herein as a “compressing section”) 101 receives the video and audio signals, thereby generating an MPEG-2 program stream (which will be referred to herein as an “MPEG2-PS”) compliant with the MPEG-2 system standard. The processing of generating a moving picture stream compliant with the MPEG-2 system standard from the video signal and the audio signal is well known in the art and detailed description thereof will be omitted herein. The MPEG2-PS generated may be decoded in accordance with the MPEG-2 system standard. The MPEG2-PS will be described in further detail later.

In accordance with the instruction given by the writing control section 141, the writing section 120 controls the pickup 130, thereby writing data at a particular location (i.e., address) on the DVD-RAM disk 131. More specifically, the writing section 120 writes the MPEG2-PS, generated by the compressing section 101, on the DVD-RAM disk 131.

The buffer memory temporarily stores the moving picture stream yet to be written on the DVD-RAM disk 131.

In accordance with the instruction given by the writing control section 141, the continuous data area detecting section (which will be simply referred to herein as a “detecting section”) 140 checks the availability of sectors, which are managed by the logical block management section 143, thereby detecting a physically continuous unused area available.

The writing control section 141 calculates the required minimum area length of continuous data areas and notifies the detecting section 140 of that length, thereby instructing the detecting section 140 to detect unused areas, of which the lengths are at least equal to the minimum area length. On being notified by the detecting section 140 that such unused areas have been detected, the writing control section 141 instructs the writing section 120 to write the data on those unused areas. A specific method of calculating the minimum area length of continuous data areas will be described later.

The logical block management section (which will be simply referred to herein as “management section”) 143 manages the use of sectors on the DVD-RAM disk 131.

Next, the MPEG2-PS 20 generated by the compressing section 101 will be described with reference to FIG. 5. FIG. 5 shows the data structure of the MPEG2-PS 20. The program stream 20 includes a plurality of video object units (VOBUs) 21. Each VOBU 21 includes a plurality of video packs V_PCK 22 in which video data is stored and a plurality of audio packs A_PCK in which audio data is stored. These are data of which the length corresponds to a video playback duration of 0.4 to 1.0 second. Each video pack 22 consists of a pack header 22a, a packet header 22b and compressed video data 22c. On the other hand, each audio pack includes audio data instead of the video data 22c of the video pack 22. If the video data has a variable bit rate, the data size of each VOBU is changeable within a range defined by a maximum read/write rate. However, if the video data has a fixed bit rate, the data size of each VOBU is substantially constant. A “pack” is generally known as an exemplary form of a packet.

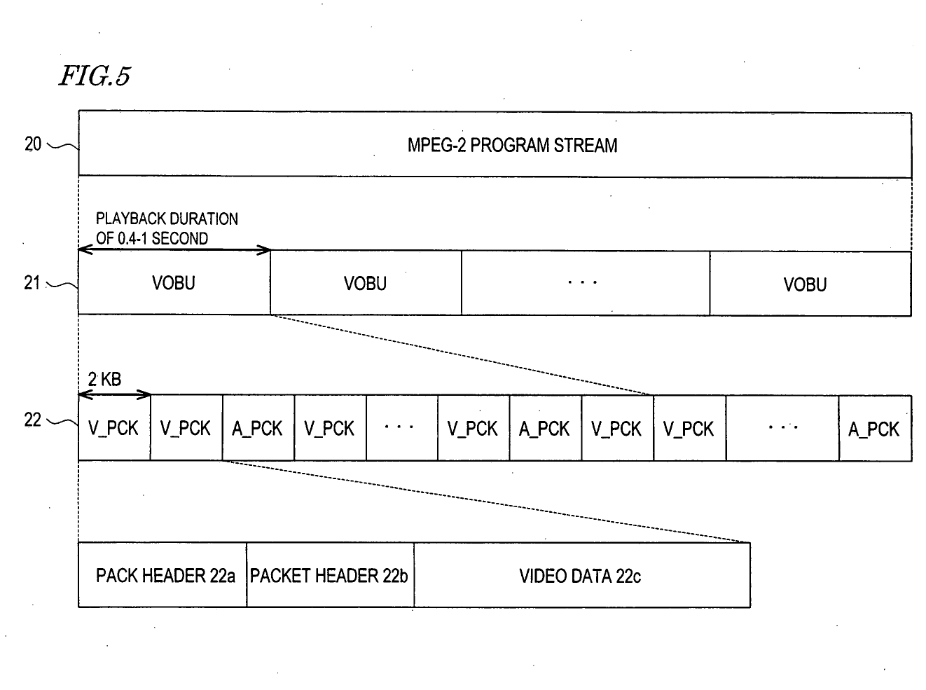

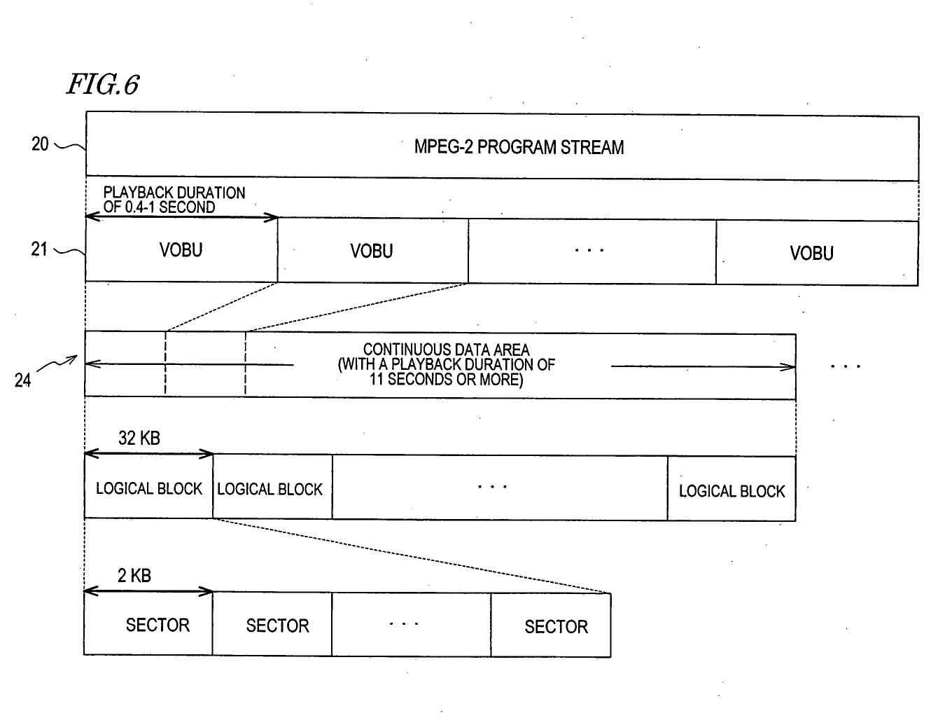

FIG. 6 shows a relationship between the program stream 20 and the storage area of the DVD-RAM disk 131. Each VOBU of the program stream 20 is written on the continuous data area 24 of the DVD-RAM disk 131. The continuous data area 24 consists of physically continuous logical blocks and can store data corresponding to a video playback duration of at least 11 seconds when the data is played back at the maximum rate. The data processor 90 adds an error correction code to each logical block. The data size of each logical block is 32 kilobytes. Each logical block includes sixteen 2 KB sectors.

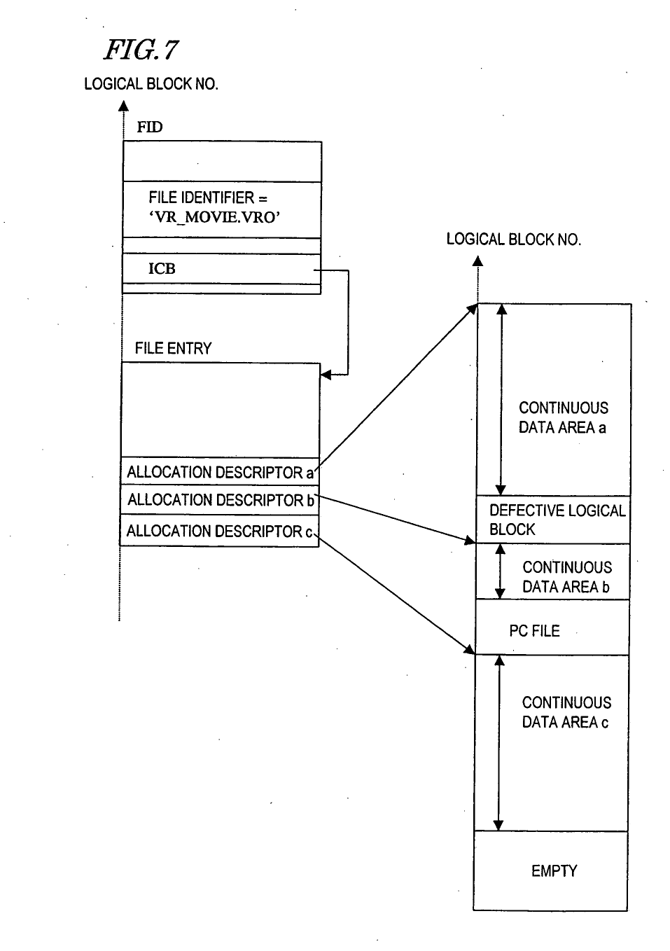

FIG. 7 shows how the data stored is managed by the file system of the DVD-RAM disk 131. In this case, either a file system compliant with the Universal Disk Format (UDF) standard or a file system compliant with ISO/IEC 13346 (Volume and File Structure of Write-Once and Rewritable Media Using Non-Sequential Recording for Information Interchange) may be used. In FIG. 7, the continuously written program stream is stored under the file name “VR_MOVIE.VRO”. As the location of the file entry that makes up the file, a top sector number is defined. The file entry includes allocation descriptors a through c for managing the continuous data areas (CDAS) a through c, respectively. One file is divided into these multiple areas a through c because there is a defective logical block, a non-writable PC file or something like that in the middle of the area a.

In FIG. 7, the continuous data area a and the area that includes the defective logical block are shown as two separate areas. In the following description, however, the defective logical blocks are supposed to be present at a predetermined defect rate or less, or the defective logical blocks and PC files are supposed to be included, in a “continuous data area” in a broader sense, which is called as such considering its defect rate. That is to say, the defective logical blocks, PC files and other “non-content data” that are not to be played back are also supposed to form respective parts of a so-called “continuous data area” in a broader sense considering its defect rate.

As used herein, the “defect rate” means the percentage of non-content data in a data area with the minimum continuous length (corresponding to 11 seconds). Meanwhile, if a continuous data area is longer than the minimum continuous length (e.g., corresponds to 15 seconds), then the first portion of the continuous data area, corresponding to the first 11 seconds, is supposed to have a defect rate of a predetermined value (e.g., 5%) and the rest of the continuous data area, corresponding to the remaining 4 seconds, is also supposed to have the same predetermined defect rate (e.g., 5%).

It should be noted that the UDF standard corresponds to a subset of the ISO/IEC 13346 standard. Also, if an optical disk drive (i.e., the data processor 90) is connected to a PC, for example, through a 1394 interface and an SBP (serial bus protocol)-2, then the PC can process a recorded file as a single file.

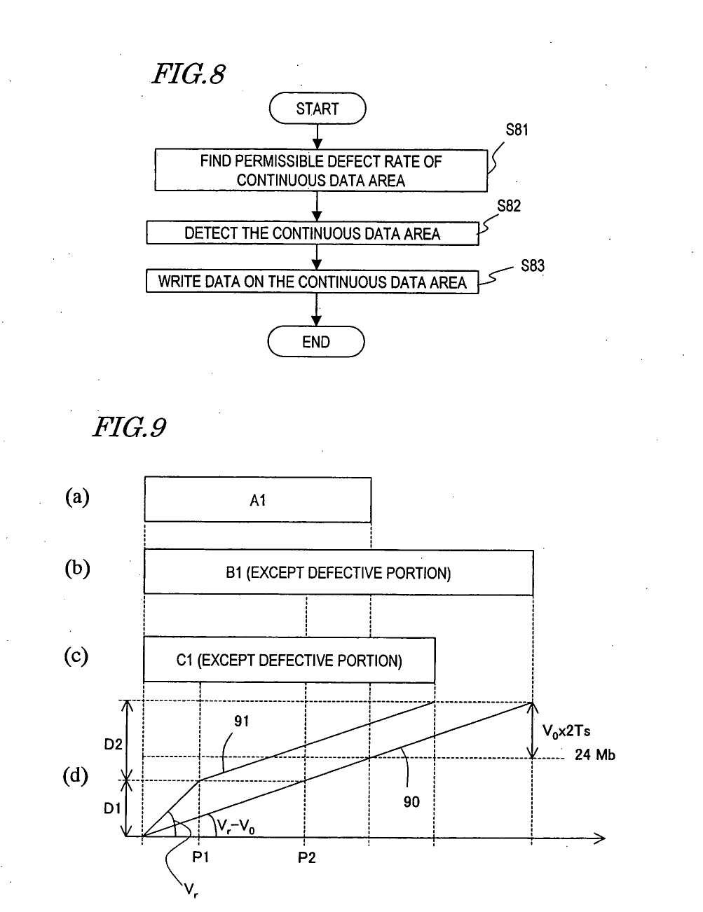

Hereinafter, it will be described how the data processor 10 performs its recording processing. FIG. 8 shows a procedure of the recording processing done by the data processor 10 of this preferred embodiment. First, in Step S81, the writing control section 141 finds the defect rate that a continuous data area of a given optical disk is permitted to have. As used herein, the “defect rate” is the percentage of non-content data (including data sizes of defective logical blocks and used logical blocks in the continuous data area) to the minimum continuous length of a continuous data area. In this preferred embodiment, the defect rate is supposed to be 5% or less per minimum continuous length. It should be noted that the permissible defect rate changes according to the logical standard or application standard of the given optical disk and is the maximum value defined by the standard. Also, the degree of generability of defective logical blocks changes with the type of the material or the recording/playback method of the optical disk. The maximum value defined by the standard may be stored in a read-only memory (ROM, not shown) that is built in a data processor just before the processor is shipped, for example.

Next, in Step S82, the detecting section 140 detects a continuous data area that includes not only unused data areas, which are equal to or longer than the minimum continuous length (considering the defect rate), but also non-content data at most at the defect rate found in Step S81. Subsequently, in Step S83, the writing control section 141 writes the data of a moving picture stream to be recorded on the continuous data area.

The continuous data area detected in Step S82 may be either a minimum continuous data area determined by considering the bit rate of a moving picture stream to be written or a minimum continuous data area determined by the maximum bit rate that is set for recording.

According to the recording processing shown in FIG. 8, the minimum area length of continuous areas, reserved on the DVD-RAM disk 131, can be shortened significantly compared to a conventional playback process with defective areas. This point will be described more fully with reference to portions (a) through (d) of FIG. 9. Portion (a) of FIG. 9 shows a conventional continuous data area A1 with no defective areas; portion (b) of FIG. 9 shows a conventional continuous data area B1 with a defect rate of 5%; and portion (c) of FIG. 9 shows a continuous data area C1 according to this preferred embodiment with a defect rate of 5%. Portions (b) and (a) of FIG. 9 show data areas with the defective areas removed such that the respective area lengths of the continuous data areas can be compared with each other easily. Also, each area length is supposed to be the minimum area length. It should be noted that the data length of the continuous data area C1 provided on the DVD-RAM disk 131 has only to be at least equal to the minimum area length and may be longer than the minimum area length to any degree.

Portion (d) of FIG. 9 shows variations in the amount of extra data accumulated, in which the line 90 represents the amount of data accumulated when the data is read out from the continuous data area B1 by a conventional playback process and the line 91 shows the amount of data accumulated when the data is read out from the continuous data area C1 by the playback process of this preferred embodiment. It can be seen that to accumulate the same amount of data (24M+Vo·2 Ts), the area C1 needs a shorter length than the area B1. This is because to accumulate data to an amount D1, the data must be read to a location P2 according to the conventional playback process but may be read to a location P1 (<P2) according to the playback process of this preferred embodiment. This means that the amount of data corresponding to the length of the area between the locations P1 and P2 is consumed by the playback and output of the data in the area B1.

It should be noted that the minimum continuous length of the area B1 shown in portion (b) of FIG. 9 has a bigger data size then that of the area C1 shown in portion (o) of FIG. 9. This is because it is necessary to accumulate the read data that should be consumed while the defective area of substantially 10% is skipped during a read operation on a single continuous data area.

Thus, playback processing according to this preferred embodiment will be described next. The components of the data processor 10 that perform the playback function will be described with reference to FIG. 4 first, and then the playback processing will be described. This playback processing is supposed to be carried out in a situation where an MPEG2-PS 20 has been written on at least one continuous data area C1 of the DVD-RAM disk 131 by the recording processing shown in FIG. 8.

The data processor 10 includes a video signal output section 110, an MPEG2-PS decoding section 111, an audio signal output section 112, a reading section 121, a buffer memory 122, the pickup 130 and a reading control section 142 as respective components realizing the playback function.

Upon a user's request, the data processor 10 decodes the MPEG2-PS 20 that is stored on the DVD-RAM disk 131, thereby playing back video and audio.

First, in accordance with an instruction given by the reading control section 142, the reading section 121 controls the pickup 130 so as to read a data file VR_MOVIE.VRO of the MPEG2-PS 20 from the DVD-RAM disk 131.

The reading control section 142 gives the instruction to read the file VR_MOVIE.VRO of the MPEG2-PS 20, which is the target of playback that has been selected by the user. This instruction is sent through the reading section 121 to the optical pickup 130, which reads the data from the DVD-RAM disk 131 in response. The reading control section 142 also instructs the MPEG2-PS decoding section 111 to decode the MPEG2-PS.

The buffer memory 122 temporarily stores the data of the MPEG2-PS 20 that has been read out by the reading section 121. In this buffer memory 122, an amount of data that is at least equal to the amount to be described later is accumulated such that the data to be output to the MPEG2-PS decoding section 111 does not run short even during the seek operation done by the optical pickup 130 or while the defective area on the DVD-RAM disk 131 is being skipped.

In accordance with the instruction to decode that has been given by the reading control section 142, the MPEG2-PS decoding section (which will be simply referred to herein as a “decoding sections”) 111 reads the MPEG2-PS 14 from the buffer memory 122, demultiplexes it, and then decodes the video data and audio data from the MPEG2-PS 14. The processing of playing back video and audio based on a moving picture stream compliant with the MPEG-2 System standard is already well known in the art and the detailed description thereof will be omitted herein.

The video signal output section 110 is implemented as a video signal output terminal to output the decoded video data as a video signal, while the audio signal output section 112 is implemented as an audio signal output terminal to output the decoded audio data as an audio signal.

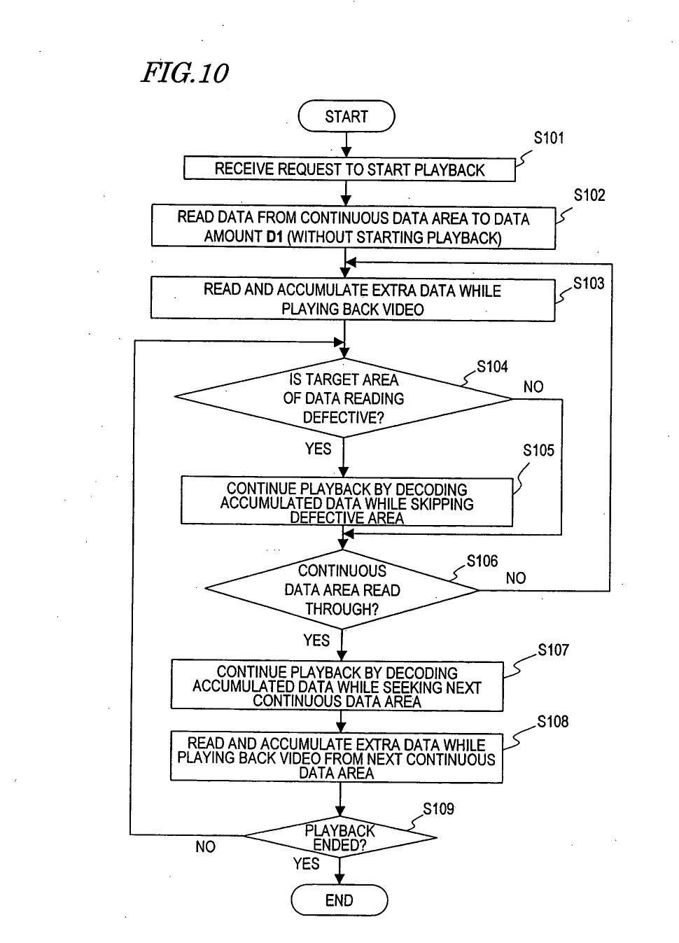

Hereinafter, playback processing according to this preferred embodiment will be described with reference to FIG. 10, which shows a procedure of the playback processing done by the data processor 10 of this preferred embodiment. First, in Step S101, the reading control section 142 receives a request to start playback from the user. Next, in Step S102, the reading control section 142 instructs to read an MPEG2-PS from a continuous data area to a data amount D1. At this point in time, the reading control section does not instruct the decoding section 111 to start decoding yet, and therefore, playback of video and/or audio is not started yet and the MPEG2-PS is accumulated to the data amount D1 in the buffer memory 122.

Subsequently, in Step S103, the reading control section 142 instructs the decoding section 111 to start decoding and playing back video and to read the MPEG2-PS from the DVD-RAM disk 131 at the same time. By setting the rate at which the data is read from the DVD-RAM disk 131 higher than the rate at which the data is output from the buffer memory 122, extra data is read. As a result, the MPEG2-PS is accumulated in the buffer memory 122 to an amount corresponding to the rate difference.

Thereafter, in Step S104, the reading section 121 determines whether the target area to read the data from is a defective area or not. If the answer is YES, the process advances to Step S105. Otherwise, the process jumps to Step S106. In Step S105, the reading section 121 gives an instruction to skip the defective area. Since no data is read in the meantime, no data is input to the buffer memory 122, either, and the decoding section 111 continues playback by decoding the data that has been accumulated in the buffer memory 122.

In this example, the processing step of “skipping” a defective area has been described as an exemplary technique of passing over the defective area. Alternatively, any other processing step may be adopted as well. For example, a processing step in which the data is read but does not reach the decoding section 111 (i.e., is not output to the decoding section 111) may also be adopted.

Meanwhile, in Step S106, the reading section 121 determines whether or not the continuous data area has been read through. If the answer is YES, the process advances to Step S107. Otherwise, the process goes back to Step S103 and the same processing steps S103 and so on are carried out all over again.

In Step S107, while a seek operation is being performed to find the next continuous data area under the instruction given by the reading section 121, the decoding section 111 continues the playback by decoding the data that has been accumulated in the buffer memory 122. Since no data is read in the meantime as in Step S105, no data is input to the buffer memory 122, either.

In the next processing step S108, the reading control section 142 gives an instruction to play back video from the next continuous data area. In this processing step, extra data is read and accumulated in the buffer memory 122, too.

Finally, in Step S109, the reading control section 142 determines whether the playback process has ended or not. If the answer is NO, the process goes back to processing step S104. On the other hand, if the answer is YES, the processing shown in FIG. 10 also ends.

Portion (a) of FIG. 11 shows continuous data areas Cn according to this preferred embodiment, while portion (b) thereof shows a variation in the amount of extra data that has been read out from the continuous data areas Cn and then accumulated in the buffer memory 122. The amount of data to be consumed after the playback has been started is not shown in FIG. 11.

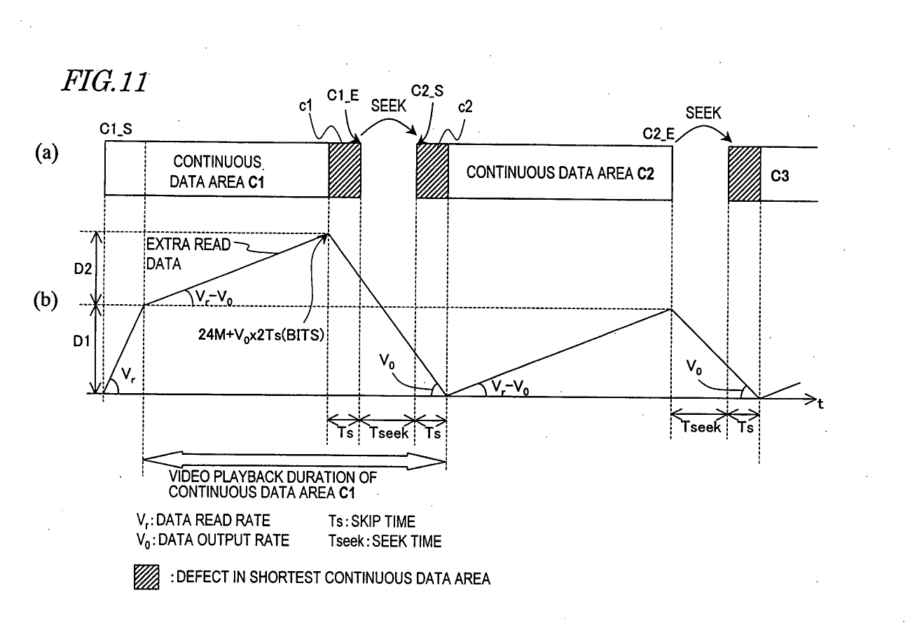

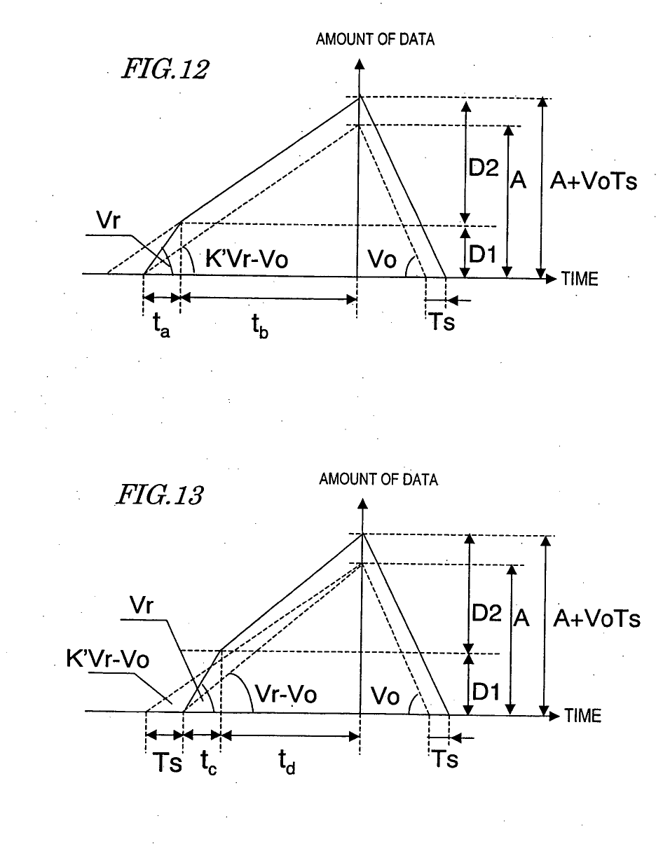

FIG. 12 shows (by the solid line) a variation in the amount of extra data that has been read out from a continuous data area C1 during the playback operation and then accumulated in the buffer memory 122. The read time length of an interval that should be read out before the playback is started is identified by tₐ. Unlike the example shown in FIG. 11, FIG. 12 shows a situation where non-content-data areas are dispersed within the continuous data area. In this example, the top data of the first continuous data area is just read for the period of time tₐ without being played back during the playback operation and then read and played back simultaneously during the next period of time t_{b}. As a result, the data is accumulated in the buffer memory to an amount A+VoTs, in which VoTs is the data required to perform skipping and playback at the same time in a situation where non-content data is present at the beginning of the next continuous data area. It should be noted that the data amount A is supposed to be the amount of data accumulated in the buffer memory at least when the shortest continuous data area with a zero defect rate is read.

As can be seen from FIG. 12, the following Equations (1) and (2) are satisfied:
K′Vrtₐ+(K′Vr−Vo)t_{b}=A+VoTs (1)
(K′Vr−Vo)(tₐ+t_{b})=A (2)
where K′=1−K. Thus, it can be seen that the read time length tₐ may be equal to the time Ts it takes to skip the non-content data, of which the length is equal to or shorter than the minimum continuous length, as represented by the following Equation (3):
tₐ=Ts (3)

FIG. 13 shows (by the solid line) a variation in the amount of extra data that has been read out from the continuous data area C1 during the playback operation of this preferred embodiment and then accumulated in the buffer memory 122. The read time length of an interval that should be read out before the playback is started is identified by (Ts+tc). FIG. 12 shows an example in which the non-content data is distributed relatively uniformly in the continuous data area. On the other hand, FIG. 13 shows an example in which the non-content data is concentrated at the top of the first continuous data area. Before the playback is started, the data in the top portion of the continuous data area is just accumulated in the buffer memory without being played back for the period of time (Ts+Tc). In this case, if the non-content data is concentrated at the top portion, then the data will not be accumulated in the first interval with the time length Ts but start to be accumulated in the next interval with the time length To as shown in FIG. 13. And even if the playback is started-when the amount of the accumulated data reaches D1, the data will also be accumulated, as in the example shown in FIG. 12, to the required amount (A+VoTs), in which VoTs is the data required to perform skipping and playback at the same time in a situation where non-content data is present at the beginning of the second continuous data area.

The time length To for accumulating such required data can be obtained as follows. As can be seen from FIG. 13, the following Equations (4) and (5) are satisfied:
Vrt_{c}+(Vr−Vo)t_{d}=A+VoTs (4)
(Vr−Vo)(t_{c}+t_{d})=A (5)

Thus, the following Equation (6) is derived:
t_{c}=Ts (6)
where K′=1−K. Accordingly, if the first continuous data area is just read for the period of time 2×Ts without being played back, then the required amount of data will always be accumulated in the buffer memory, irrespective of the distribution of the non-content data. The amount D1 of data that should be just read without being played back is given by D1=Vr·Ts as can be seen from Equations (14) and (3) that will be used for the second preferred embodiment to be described later. Accordingly, the playback may also be started when the data is accumulated to the amount D1 in the buffer memory. According to the latter technique, the amount of data to be read before the playback is started may be smaller in many cases.

In the following description, the rate Vr of reading data from the DVD-RAM disk 331 is supposed to be 11 Mbps, the maximum rate Vo of outputting the data to the MPEG-2 decoding section 311 is supposed to be 8 Mbps, and the longest time it takes to move the pickup (i.e., the longest seek time) is supposed to be 3 seconds. Also, the MPEG2-PS 20 is supposed to be read sequentially from the continuous data area C1. Furthermore, the hatched defective area is supposed to be included at the end of the continuous data area C1. As already described for the processing step S102 (see FIG. 10), since no playback is carried out until the amount of data accumulated reaches D1, the data is accumulated in the buffer memory 122 at the data read rate Vr. Since the playback is started after that, data will be stored in the buffer memory 122 to the amount D2 at the rate corresponding to the difference between the data read rate Vr and the data output rate Vo.

When the MPEG2-PS 20 has been read until just before the defective area of the continuous data area C1, data of (24M+Vo·2 Ts) bits will have been accumulated in the buffer memory 122. In 24M+Vo·2 Ts, 24 megabits is calculated as the product of the data output rate Vo (=8 Mbps) and the longest seek time Tseek of 3 seconds and represents the maximum amount of data to be output. Meanwhile, Vo·2 Ts is the amount of data obtained considering that no data can be read during the period of time Ts for skipping the defective area in the continuous data area C1 and during the period of time Ts for skipping the defective area that may be present at the beginning of the next continuous data area C2. In this example, the defective area is supposed to be present at the top. Actually, however, this supposition is adopted considering the situation where defective areas are present in the second area as counted from the top or in the ECC block that follows the second area.

Thereafter, the MPEG2-PS 20 will be read out from the next continuous data area C2 while the data continues to be played back. Accordingly, the data will be accumulated in the buffer memory 122 at the rate (Vr−Vo).

When the MPEG2-PS 20 has been read through the end of the continuous data area C2, the amount of data accumulated in the buffer memory 122 will be Vo·(Tseek+Ts). This data amount is the minimum required amount of data that allows the decoding section 111 to decode and play back video and/or audio even if it takes the longest seek time Tseek to jump from the continuous data area C2 to the next continuous data area C3 and if a defective area is present at the top of the continuous data area C3.

As described above, by reading and accumulating a certain amount of data when a continuous data area starts to be read and not playing back the data in the meantime, the area length of the continuous data area to be provided can be determined by considering the time it takes to skip the defective areas of the continuous data area. According to the conventional process, the area length of the continuous data area is determined by additionally taking the time Ts it takes to skip the defective area of the next continuous data area into consideration. Thus, the amount of data can be saved by that additional amount of time. Consequently, in locating a continuous data area to store data newly, the area can be detected more easily and the empty areas of the storage medium can be used more effectively. In addition, the moving picture files on the disk can be edited on a shorter unit, and therefore, editing can be done easily and it takes a shorter time to get the rewrite process done.

In the preferred embodiment described above, if a continuous data area is equal to or longer than the minimum continuous length, then the first portion of the continuous data area, corresponding to the minimum continuous length, is supposed to have a defect rate that is equal to or smaller than a predetermined value and the rest of the continuous data area is also supposed to have the same defect rate. However, in a single continuous data area, the percentage of non-content data to an arbitrary interval with the minimum continuous length may be less than the predetermined defect rate.

### Embodiment 2

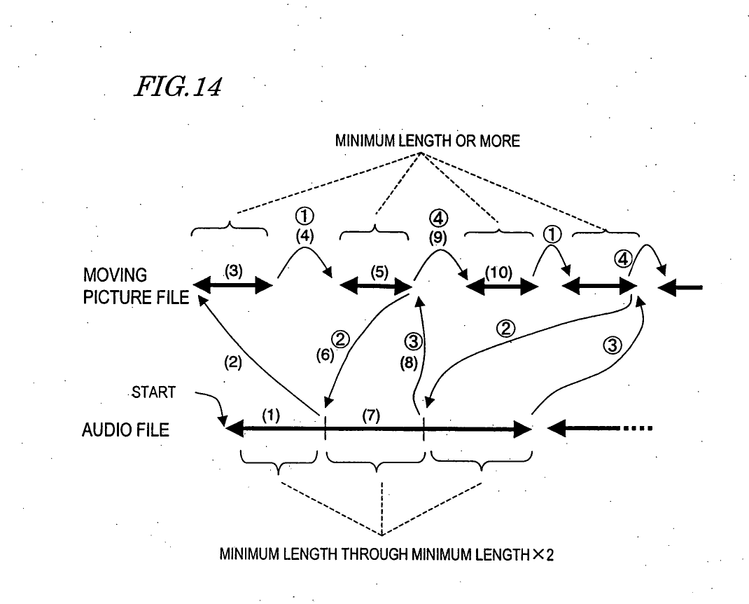

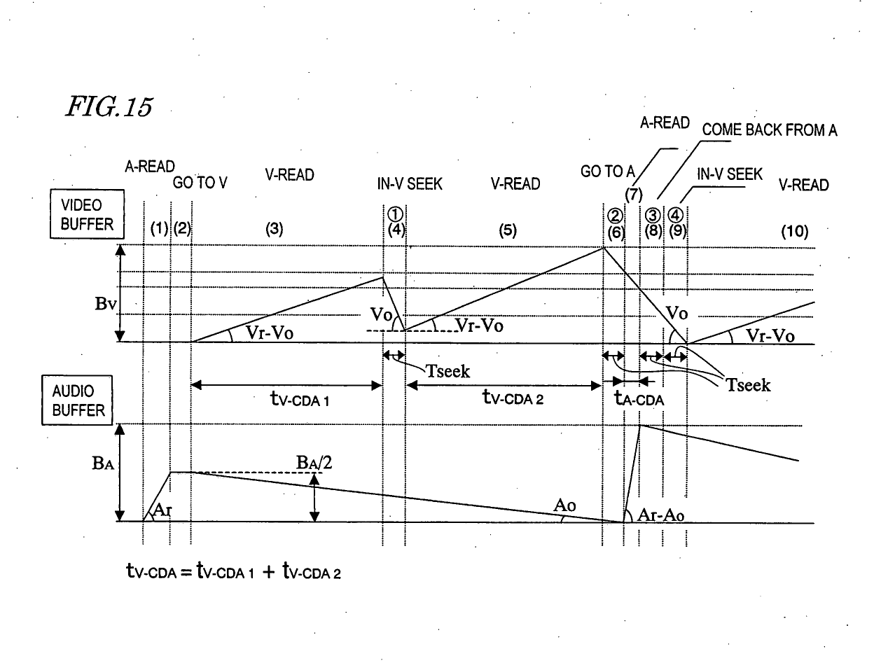

Hereinafter, an exemplary application of the first preferred embodiment will be described with reference to FIGS. 14 and 15. In the foregoing description, the amount of extra data to be read is supposed to be calculated based on the data read rate Vr and data output rate Vo of video data.

In the following example, it will be described how the minimum area length of continuous data areas may be defined with the data read rate Ar and data output rate Ao of audio data further taken into consideration.

The data processor of this preferred embodiment has the same functions and configuration as the counterpart 10 shown in FIG. 4. Thus, the following operation is also supposed to be performed by the data processor 10 shown in FIG. 4.

Also, for the sake of convenience, video data is supposed to be stored in a moving picture file and audio data is supposed to be included in an audio file, which is provided separately from the moving picture file, in the following description. Furthermore, in a moving picture continuous data area, in which the moving picture file is stored, non-video data that is not to be played back is supposed to be included at a frequency of occurrence, which is less than, and different from, the defect rate. Likewise, in an audio continuous data area, in which the audio file is stored, non-audio data that is not to be reproduced is supposed to be included at a frequency of occurrence, which is less than, and different from, the defect rate. That data not to be played back will be referred to herein as “non-content data”. Also, since video data and audio data are accumulated separately in the buffer memory 122, an area of the buffer memory 122 in which the video data is accumulated will be referred to herein as a “video buffer” and another area of the buffer memory 122 in which the audio data is accumulated will be referred to herein as an “audio buffer” for the sake of convenience.

FIG. 14 shows the order of operations to be done by the pickup 130 in playing back video and audio synchronously with each other. Data read operations are carried out in (1), (3), (5), (7) and (10) and seek operations between areas are carried out in (2), (4), (6), (8) and (9). Each of the encircled numbers \textcircled{1}, \textcircled{2}, \textcircled{3} and \textcircled{4} represents one period.

In FIG. 14, the maximum permissible number n of moving picture continuous data areas that can be read within one period is supposed to be two. However, n may be equal to seven, for example. The bigger the number n, the smaller the data size of each moving picture continuous data area can be. In that case, however, the size of a buffer to store the audio continuous data area increases. That is why n needs to be selected appropriately.

FIG. 15 shows variations in the respective amounts of video data and audio data to be accumulated in the buffer memory 122 in a situation where those data are read in the order of reading shown in FIG. 12. The numbers (1), (2) and so on shown in FIG. 14 correspond to their counterparts shown in FIG. 15. Likewise, the encircled numbers shown in FIG. 15 also correspond to their counterparts shown in FIG. 14. In FIG. 15, the minimum amount of time it takes to read data from the moving, picture continuous data area during the synchronous playback operation is identified by t_{V-CDA} and the amount of time it takes to read data from the audio continuous data area is identified by t_{A-CDA}.

If non-content data is detected in a continuous data area either during reading or at the beginning of reading, then the optical pickup 130 needs to skip the non-content data storage area until data to be played back is detected. The amount of time it takes to skip a non-content data storage area, which exceeds the defect rate, within a moving picture continuous data area is identified by T_{SV}, the amount of time it takes to skip that area within an audio continuous data area is identified by T_{SA} and the sum of T_{SV} and T_{SA} is identified by T_{S}.

For example, if a part of the last ECC block of a moving picture continuous data area is a file tail compliant with the UDF standard, then the time to skip one ECC block is represented by T_{ECC}. And if each of n continuous data areas includes a file tail, then T_{S}, T_{SV} and T_{SA} are represented by the following Equations (7), (8) and (9), respectively:
T_{S}=T_{SC}+T_{SA} (7)
T_{SV}=n×T_{ECC} (8)
T_{SA}=0 (9)

Next, considering the skip time in the worst case shown in the timing diagram of FIG. 15, the following equations are satisfied:
(K′Vr″Vo)t_{V-CDA}=Vo×((n+2)×T_{SEEK}+Ts+T_{A-CDA}) (10)
(K′Ar−Ao)t_{A-CDA}=Ao×((n+2)×T_{SEEK}+Ts+t_{V-CDA})×2 (11)
K′=1−K (12)
where K is the maximum allowable defect rate per minimum continuous length. In Equation (12), K′ represents the ratio of the area that can be used as a data area. In this case, the amount of time it takes to read each moving picture continuous data area multiplied by n is:

$${t}_{V - CDA} = \frac{Vo \times [ ( n + 2 ) \times {T}_{SEEK} + Ts ] ( 1 + Ao / ( {K}^{′} Vr ) )}{( {K}^{′} Vr ) - Vo - Ao - AoVo / ( {K}^{′} Vr )} \qquad ( 13 )$$

Considering the defect rate, the minimum playback duration t_{V-play of the moving picture continuous data areas is given by:}

$$\begin{matrix}{t}_{V - play} = {t}_{V - CDA} ( {K}^{″} Vr / ( nVo ) \\ = \frac{1}{n} \times \frac{Vo \times [ ( n + 2 ) \times {T}_{SEEK} + Ts ] ( 1 + Ao / ( {K}^{′} Vr ) )}{( {K}^{′} Vr ) - Vo - Ao - AoVo / ( {K}^{′} Vr )}\end{matrix} \qquad ( 14 )$$

The minimum size S_{V-CDA} of the moving picture continuous data areas is:
S_{V-CDA}=t_{V-CDA}×Vr/(n Vo) (15)

The size Bᵥ of the moving picture buffer is:
Bᵥ=Vo×(3×T_{SEEK}+t_{A-CDA}) (16)

Considering the defect rate, the maximum amount of time t_{A-CDA} it takes to read the audio continuous data areas (which is twice as large as the minimum value) is given by:

$${t}_{A - CDA} = \frac{2 \times ( n + 2 ) \times {AoT}_{SEEK}}{( {K}^{′} Vr ) - Vo - Ao - AoVo / ( {K}^{′} Vr )} \qquad ( 17 )$$

The minimum playback duration t_{A-PLAY} of the audio continuous data areas is given by:

$$\begin{matrix}{t}_{A - play} = ( {t}_{A - CDA} / 2 ) \times ( {K}^{′} Vr ) / Ao \\ = \frac{{K}^{′} Vr \times ( n + 2 ) \times {T}_{SEEK}}{( {K}^{′} Vr ) - Vo - Ao - AoVo / ( {K}^{′} Vr )}\end{matrix} \qquad ( 18 )$$

The minimum size S_{A-CDA} of the audio continuous data areas is:

$${S}_{A - CDA} = Vr \times \frac{{t}_{A - CDA}}{2} \qquad ( 19 )$$

The size B_{A} of the audio buffer is:
B_{A}(K′Ar−Ao)t_{A-CDA} (20)

In this manner, the minimum sizes S_{V-CDA} and S_{A-CDA} of moving picture continuous data area and audio continuous data area can be figured out.

In the preferred embodiment described above, the storage medium is supposed to be a DVD-RAM disk 131. However, the present invention is in no way limited to that specific preferred embodiment. Alternatively, an optical disk such as a Blu-ray disc, an MO, a DVD-R, a DVD-RW, a DVD+RW, a CD-R, or a CD-RW, a hard disk, or any other type of storage medium may also be used as long as the storage medium involves the head's seek operation and defective areas. As another alternative, a flash memory may also be used if the continuous data areas and defective areas can be defined for the memory. Although the read/write head is supposed to be the optical pickup 130 in the foregoing description, an appropriate type of head actually needs to be selected according to the type of given storage medium. For example, if the given storage medium is an MO, the read/write head should include an optical pickup and a magnetic head. On the other hand, if the storage medium is a hard disk, then the read/write head should be a magnetic head.

Also, in the preferred embodiment described above, the data processor 10 is supposed to have both the functions of recording and playing back a moving picture stream representing video and/or audio. However, a read-only device with no recording function may also be used. In that case, the data processor may have only the blocks performing the playback function described above.

Furthermore, in the preferred embodiment described above, a program stream is supposed to be recorded. Naturally, the program stream may be replaced with a transport stream, a PES stream, a QuickTime stream, an AVI file data stream or any other suitable stream.

On top of that, each continuous data area for recording a content thereon is supposed to be equal to or longer than the minimum continuous length in the preferred embodiment described above. However, a continuous data area including the beginning and end of a content may be shorter than the minimum continuous length. In that case, to play back the content seamlessly, it is naturally necessary to accumulate data to get ready for the pickup's seek operation before that content starts to be played back.

What is more, in the preferred embodiment described above, the data size of a continuous data area is calculated by converting the area length into a playback duration. However, the playback duration can be easily converted into a bit length by multiplying the playback duration by a read bit rate.

The file system of the optical disk is supposed to be compliant with UDF in the preferred embodiment described above, but may also be compliant with FAT, UFS (Unix File System) or NTFS, for example.

Although the video is supposed to be presented as an MPEG-2 video stream in the preferred embodiment described above, an MPEG-4 video stream, an MPEG-4 AVC stream or any other suitable data stream may also be used. Also, the video and audio are supposed to have variable bit rates in the preferred embodiment described above but those rates may be fixed, too. Furthermore, in the preferred embodiment described above, the minimum continuous length is supposed to be determined by the playback method shown in FIG. 2 or 15. However, the minimum continuous length may also be defined by a different playback method.

The data processor of the preferred embodiment described above processes a moving picture stream. However, it is just an example. Alternatively, an audio stream, a graphic data stream, or a data stream representing a program that is described in JAVA language to be executed in real time may also be processed. Optionally, the data processor may also be a fixed video recorder to record a broadcast wave or a camcorder for shooting videos.

Those functions of the data processor 10 may also be realized by executing a software program. For example, by executing a software program, a central processing unit (CPU) as a brain of a computer may operate as (i.e., perform the functions of) the writing control section 141 and/or reading control section 142 described above. Alternatively, the CPU may control another circuit such that the circuit functions as the writing control section 141 and/or the reading control section 142 described above. As a result, a data processor 10 including the writing control section 141 and/or the reading control section 142 can also be obtained.

The computer program may be stored in any of various types of storage media. Examples of preferred storage media include optical storage media such as optical disks, semiconductor storage media such as an SD memory card and an EEPROM, and magnetic recording media such as a flexible disk. Instead of using such a storage medium, the computer program may also be downloaded via a telecommunications line (over the Internet, for example) and installed in the data processor 10.

### INDUSTRIAL APPLICABILITY

According to the present invention, a continuous data area, which is provided to guarantee continuous playback from a storage medium with a defective area and other unnecessary areas, can have a shorter area length than a conventional one. Thus, even in finding a continuous data area to get recording done newly, that area can be located easily. As a result, the empty areas on a storage medium can be used more effectively. Besides, moving picture files on the storage medium can be easily edited into a continuously playable one, and it takes a shorter time to complete a rewrite process.

1. A data processor for reading content data from a continuous area on a storage medium and playing back video and/or audio based on the content data, the continuous area including a data area, in which the content data is stored, and a non-content-data area, in which the content data is not stored, the data processor comprising:
a reading control section for giving an instruction to read the content data of a predefined size from the data area and an instruction to start to play back the video and/or the audio based on the content data that has been read out;
a head for reading the content data from the data area in accordance with the instruction to read; and
a buffer memory for accumulating the content data that has been read,
wherein the reading control section determines the predefined size by the amount of time it takes to skip the non-content-data area, reads the content data of the predefined size, accumulates the data in the buffer memory, and then gives an instruction to start to play back the content.

2. The data processor of claim 1, wherein the reading control section determines the predefined size by a data read rate at which the content data is read.

3. The data processor of claim 1, wherein the content data is encoded data representing the video and/or the audio, and
wherein the data processor further includes a decoding section for reading the content data of the predefined size from the buffer memory and decoding the content data in accordance with the instructions given by the reading control section.

4. The data processor of claim 1, wherein the minimum area length of the continuous area is determined by a data read rate, which has been defined based on a required data rate to play back the content and on a unit time to perform the playback, and by the size of extra data to be accumulated in the buffer memory, and
wherein the size of the extra data is determined by a data size, which has been defined on the longest seek time it takes to reach the next continuous area and a data rate required for playback during the longest seek time, and by the predefined size.

5. The data processor of claim 1, wherein the noncontent-data area includes at least one of a defective area, of which the area length corresponds to at most a permissible defect rate for the continuous area, and a data area including data other than the content data.

6. The data processor of claim 5, wherein the continuous area has an area length that is at least equal to the minimum 15 area length.

7. A data processor for reading content data from a continuous area on a storage medium and playing back video and/or audio based on the content data, the continuous area including a data area, in which the content data is stored, and a non-content-data area, in which the content data is not stored, the data processor comprising:
a reading control section for giving an instruction to read the content data from the data area for a predetermined period of time and an instruction to start to play back the video and/or the audio based on the content data that has been read out;
a head for reading the content data from the data area in accordance with the instruction to read; and
a buffer memory for accumulating the content data that has been read,
wherein the reading control section determines the predetermined period of time by the amount of time it takes to skip the non-data area, reads the content data for the predetermined period of time, accumulates the data in the buffer memory, and then gives an instruction to start to play back the content.

8. A data processing method for reading content data 20 from a continuous area on a storage medium and playing back video and/or audio based on the content data, the continuous area including a data area, in which the content data is stored, and a non-content-data area, in which the content data is not stored, the method comprising the steps of:
giving an instruction to read the content data of a predefined size from the data area;
reading the content data from the data area in accordance with the instruction to read;
accumulating the content data that has been read; and
giving an instruction to start to play back the video and/or the audio based on the content data,
wherein the step of giving an instruction to read includes determining the predefined size by the amount of time it takes to skip the non-data area, and
wherein the step of giving an instruction to start to play back includes accumulating the content data of the predefined size by performing the step of accumulating and then giving the instruction to start to play back.

9. The data processing method of claim 8, wherein the step of giving an instruction to read includes determining the predefined size by a data read rate at which the content data is read.

10. The data processing method of claim 8, wherein the content data is encoded data representing the video and/or the audio, and
wherein the method further includes the step of decoding the content data.

11. The data processing method of claim 8, wherein the minimum area length of the continuous area is determined by a read data size, which has been defined based on a required data rate to play back the content and on a unit time to perform the playback, and by the size of extra data to be accumulated in the buffer memory, and
wherein the size of the extra data is determined by a data size, which has been defined on the longest seek time it takes to reach the next continuous area and a data rate 20 required for playback during the longest seek time, and by the predefined size.

12. The data processing method of claim 11, wherein the continuous area has an area length that is at least equal to 5 the minimum area length.

13. The data processing method of claim 8, wherein the non-content-data area includes at least one of a defective area, of which the area length corresponds to at most a permissible defect rate for the continuous area, and a data area including data other than the content data.

14. A data processing method for reading content data from a continuous area on a storage medium and playing back video and/or audio based on the content data, the continuous area including a data area, in which the content data is stored, and a non-content-data area, in which the content data is not stored, the method comprising the steps of:
giving an instruction to read the content data from the data area for a predetermined period of time;
giving an instruction to start to play back the video and/or the audio based on the content data that has been read;
reading the content data from the data area in 5 accordance with the instruction to read; and
accumulating the content data that has been read,
wherein the step of giving an instruction to read includes determining the predetermined period of time by the amount of time it takes to skip the non-data area, and
wherein the step of giving an instruction to start to play back includes reading the content data for the predetermined period of time and accumulating the content data in the buffer memory by performing the step of accumulating and then giving the instruction to start to play back the content.
